(19) United States
(12) Patent Application Publication
(10) Pub. No.: US 2013/0040256 A1
(43) Pub. Date: Feb. 14, 2013

(54) METHOD FOR PRE-HEATING ANNEALING MATERIAL IN A HOOD-TYPE ANNEALING SYSTEM

(71) Applicants: Robert Ebner, Leonding (AT); Andreas Sauschlager, Leonding (AT); Christian Sandner, Gmunden (AT)

(72) Inventors: Robert Ebner, Leonding (AT); Andreas Sauschlager, Leonding (AT); Christian Sandner, Gmunden (AT)

(73) Assignee: EBNER INDUSTRIEOFENBAU GMBH, Leonding (AT)

(21) Appl. No.: 13/640,772

(22) PCT Filed: Apr. 7, 2011
(86) PCT No.: PCT/AT11/00166

§ 371 Date: Oct. 17, 2012

(30) Foreign Application Priority Data
Apr. 14, 2010 (AT) A 590/2010

(51) Int. Cl. F27B 5/16

(52) U.S. Cl. 432/9; 432/200

(57) ABSTRACT

A method is described for preheating annealing material (4, 5) in a hood-type annealing system, comprising annealing bases (1, 2) which accommodate the annealing material (4, 5) under a protective cover (7) in a protective gas atmosphere, with the annealing material (4) to be subjected to a heat treatment in a protective cover (7) being preheated with the help of a gaseous heat carrier which flows in a cycle around the protective covers (7) on the outside and absorbs heat from annealing material (5) which is already heat-treated in a protective cover (7) and emits it to the annealing material (4) to be preheated in the other protective cover (7). In order to achieve advantageous utilization of the thermal energy it is proposed that for the heat treatment of the annealing material (4, 5, 6) at least one further annealing base (3) is used which comprises a protective hood (7) which is heatable from the outside by a burner (15), and that the hot exhaust gases from the heating of the protective hood (7) are admixed into the heated heat carrier for preheating the annealing material (4).

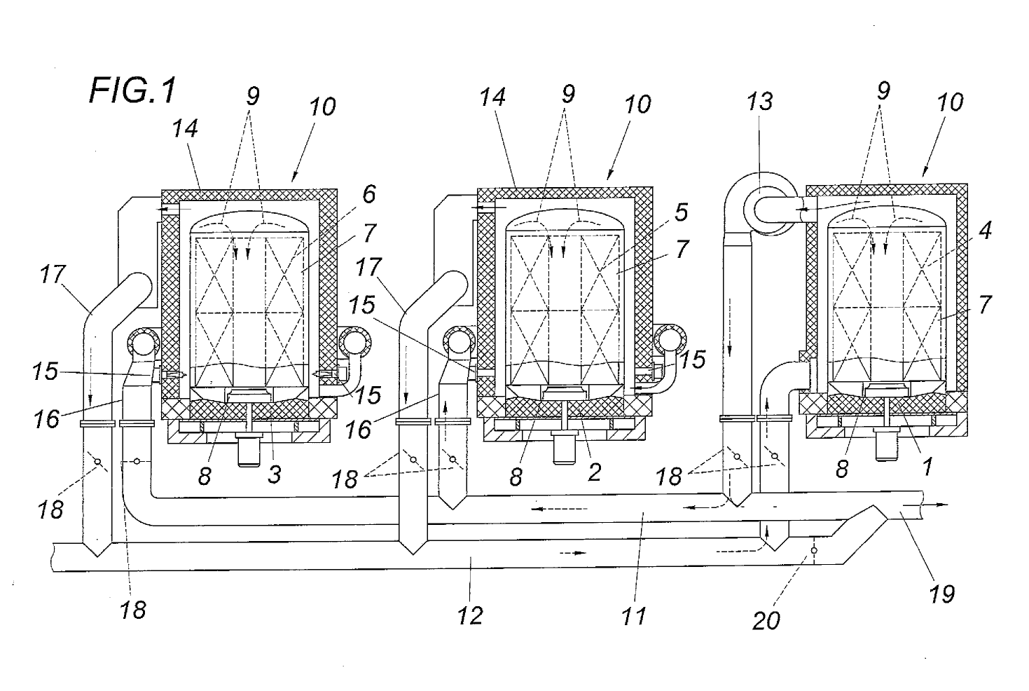

### 1. FIELD OF THE INVENTION

The invention relates to a method for preheating annealing material in a hood-type annealing system, comprising annealing bases which accommodate the annealing material under a protective cover in a protective gas atmosphere, with the annealing material to be subjected to a heat treatment under a protective cover being preheated with the help of a gaseous heat carrier which flows in a cycle around the protective covers on the outside and absorbs heat from annealing material which is already heat-treated in a protective cover and emits it to the annealing material to be preheated in the other protective cover.

### 2. DESCRIPTION OF THE PRIOR ART

The annealing material which is accommodated by an annealing base is heated under a protective hood in a protective gas atmosphere for the heat treatment of annealing material such as hot-formed or cold-formed strips or wires, which occurs with the help of a heating cover which is placed over the protective cover which is heated via gas burners for example. During the heat treatment, the lubricant residues adhering to the annealing material will evaporate and be removed from the protective cover with a partial stream of the protective gas. The annealing material is cooled again after the heat treatment. In order to enable the utilization of a part of the heat obtained during the cooling of the annealing goods for preheating the annealing material that yet needs to be subjected to a heat treatment, it is known in hood-type annealing systems with at least two annealing bases to provide a flow connection for recirculating a gaseous heat carrier between the protective covers of two annealing bases which on the one hand already carry hot annealing material that has already been subjected to heat treatment and on the other hand cold annealing material that will be subjected to such a treatment, so that the heat absorbed from the heat carrier within the protective cover with the hot annealing material can be used for preheating the cold annealing material in the other protective cover, which comes with the disadvantage however that as a result of the cycle guidance of the heat carrier there is a likelihood that lubricants which evaporate during the preheating of the cold annealing goods will contaminate the heat-treated annealing material that has already been cleansed from lubricants. If the direct contact of the hot and cold protective gas is to be avoided, a complex additional heat exchange is necessary between the protective gas flows. Moreover, the protective gas flows need to be guided through large openings in the annealing base, leading to high safety risks.

### SUMMARY OF THE INVENTION

The invention is therefore based on the object of providing a method of the kind mentioned above for preheating annealing material in a hood-type annealing system in such a way that the energy used for the heat treatment of the annealing material can be utilized advantageously without having to contend with the likelihood of contamination of the annealing material that is to be subjected to heat treatment.

This object is achieved by the invention in such a way that for the heat treatment of the annealing material at least one further annealing base is used which comprises a protective hood which is heatable from the outside by a burner, and that the hot exhaust gases from the heating of said protective hood are admixed into the heated heat carrier for preheating the annealing material.

Since as a result of this measure not only a portion of the heat obtained during the cooling of the annealing material after its heat treatment is used for the preheating of the as yet untreated annealing material, but in addition also a portion of the sensible waste heat of the exhaust gases which are obtained during the heating of the preheated annealing material to the treatment temperature and which have a higher temperature than the heat carrier after the pre-cooling of the annealing material, the applied thermal energy can be utilized better and the annealing material can be heated more rapidly to the treatment temperature. The gases obtained during the heating of the annealing material to its treatment temperature will be admixed to the gaseous heat carrier which is heated during the pre-cooling of the annealing material and said gas mixture is used to be applied to the protective hood of the annealing base for preheating the annealing material, which gas mixture has a higher energy potential in comparison with the preheated heat carrier. Contamination of the annealing material via the heat is excluded due to the application of the heat carrier flow from the outside to the protective hood. The excess gas which is caused by the admixture of the exhaust gases to the heat carrier flow will be separated continuously from the heat carrier cycle, preferably from the heat carrier flow which is cooled off after the preheating of the annealing material.

For the purpose of performing the proposed method, it can advantageously be assumed that there is a hood-type annealing system with annealing bases which accommodate the annealing material under a protective hood, circulation devices associated with the protective hoods for a protective gas and cycle guidance for a gaseous heat carrier which comprises enclosures which enclose the protective hoods at a distance and flow conduits which join the enclosures with each other into a cycle. The relevant aspect in the invention is that at least one further annealing base is provided comprising a protective hood and a heating hood which encloses the protective hood and is heatable by burners, and whose exhaust gas line opens into the flow conduit for the heated heat carrier, and that the flow conduit for the cooled heat carrier is provided with an excess outlet, so that the hot exhaust gases from the heating hood will mix together in the flow conduit with the heat carrier which was heated during the pre-cooling of the already heat-treated annealing material and the annealing material to be preheated can be subjected to the gas mixture via the associated protective hood. The excess outlet is used for discharging the excess gas to be removed from the heat carrier cycle.

For the purpose of controlling the gas mixture within the flow conduit for the heated heat carrier, the cycle fan provided for the cycle guidance of the heat carrier can be triggered depending on the pressure in said flow conduit, wherein an at least approximately constant pressure is desirable in said flow conduit.

### BRIEF DESCRIPTION OF THE DRAWINGS

The method in accordance with the invention for preheating annealing material will be explained in closer detail by reference to the drawing, which shows in a schematic vertical sectional view a hood-type annealing system in accordance with the invention for annealing the annealing material.

### DESCRIPTION OF THE PREFERRED EMBODIMENT

The drawing shows three annealing bases 1, 2, 3 of a hood-type annealing system for receiving the annealing material 4, 5, 6 in batches. Every annealing base 1, 2, 3 is associated with a protective hood 7 which encloses the annealing material 4, 5, 6 from the outside and in which a protective gas is circulated in the known manner by means of a blower 8 according to the flow arrows 9. Said protective hoods 7 are arranged within enclosures 10 which are connected with each other via flow conduits 11, 12 for a gaseous heat carrier. The enclosure 10 for the annealing base 1, which enclosure is arranged as a heat-exchange hood, is associated with a cycle blower 13 for a cycle flow of the heat carrier via the flow conduits 11 and 12. Whereas the heat-exchange hood of the annealing base 1 is merely used for supplying the protective hood 7 associated with said annealing base 1, the enclosures 10 of the two other annealing bases 2 and 3 are arranged as heating hoods 14 which preferably comprise gas-operated burners 15 in order to heat the annealing material 5, 6 to the predetermined treatment temperature by applying the hot burner gases to the respective hood 7. Heat transmission occurs from the hot burner gases via the protective hood 7 onto the protective gas circulated within the protective hood 7, and from said protective gas to the annealing material 5 and 6. In contrast to conventional heating hoods, the heating hoods 14 of the hood-type annealing system in accordance with the invention comprise a connecting line 16 to the flow conduit 11 and an exhaust gas line 17 opening into the flow conduit 12. The respective flow path for the heat carrier can be determined by means of control flaps 18.

In the illustrated operating state of the hood-type annealing system, the gaseous heat carrier is guided in a cycle by means of the cycle blower 13 between the enclosure 10 of the annealing base 1 and the heating hood 14 of the annealing base 2, with the burners 15 of the heating hood 14 being deactivated once the annealing material 5 has been heated to the treatment temperature by way of the burners 15 and is ready for cooling. The heat carrier which flows through the connecting line 16 from the flow conduit 11 into the heating hood 14 of the annealing base 2 will therefore be heated by the protective hood 7 of said annealing base 2 under pre-cooling of the annealing material 5 in order to transfer its heat to the annealing material 4 on the annealing base 1 which was applied in the cold state to the annealing base 1 and is therefore preheated by supplying the heated heat carrier to the protective hood 7. While the heat obtained from cooling the annealing material 5 on the base 2 is used for preheating the cold annealing material 4 on the annealing base 1, a preheated annealing material 6 on the annealing base 3 is heated by the heating hood 14 to the treatment temperature in that the protective hood 7 for the annealing material 6 is subjected to the hot gases of the burner 15. The control flap 18 in the connecting line 16 must be closed for this heating operation. The exhaust gases from the heating hood 14 of the annealing base 3 are therefore supplied via the exhaust gas line 17 to the flow conduit 12 in which the heat carrier guided in a cycle between the enclosures 10 of the annealing bases 1 and 2 will be mixed with the exhaust gases in order to perform the preheating of the cold annealing material 4 on the annealing base 1 with the mixed gases, to which more energy is supplied by means of the admixture of the exhaust gases from the heating hood 14 of the annealing base 3 than the heat carrier will be provided with, which heat carrier is heated during the pre-cooling of the annealing material 5 on the annealing base 2, so that the thermal energy used for the heat treatment of the annealing material 6 can be used advantageously. When several annealing bases are used for heating the annealing material to the treatment temperature, the exhaust gases from all the heating hoods of said annealing base are advantageously introduced into the flow conduit 12 for the heated heat carrier.

The excess gas obtained by the introduction of the exhaust gases from the heating hood 14 of the annealing base 3 into the cycle of the heat carrier will be removed from the heat carrier cycle via an excess outlet 19, which occurs from the flow conduit 11 for the cooled heat carrier in order to discharge the excess gas with the lowest possible energy level. The control of the gas flows occurs on the one hand by the control flaps 18 and on the other hand by the pressure in the flow conduit 12 for the heated heat carrier. This pressure in the flow conduit 12 will be kept substantially constant via a respective triggering of the cycle blower 13.

The flow conduit 12 for the heated heat carrier is connected via a flap 20 with the excess outlet 19 of the flow conduit for the cooled heat carrier of the heat carrier cycle. Said flap 20 will be opened when the enclosure 10 of the annealing base 1 which is used as a heat-exchange hood has not yet been put into operation, so that the exhaust gases of the heating hood 14 of the annealing base 3 can be drawn off via a flue connected to the excess outlet 19.

After the heat treatment of the annealing material 6 on the annealing base 3, the enclosures 10 of the annealing bases 1 and 2 and the protective hood 7 of the annealing base 2 are removed. The pre-cooled annealing material 5 will finally be cooled by means of a cooling hood until it is replaced by cold annealing material that will be subjected to heat treatment. After a respective exchange of the enclosures 10, the cold annealing material can be preheated and the preheated annealing material 4 can be heated on the annealing base 1 to the treatment temperature, as has already been described above. For this purpose, the enclosures 10 with the cycle blower 13 must be placed on the annealing base 2 and the heating hood 14 of the annealing base 2 on the annealing base 1.

1. A method for preheating annealing material (4, 5) in a hood-type annealing system, comprising annealing bases (1, 2) which accommodate the annealing material (4, 5) under a protective cover (7) in a protective gas atmosphere, with the annealing material (4) to be subjected to a heat treatment in a protective cover (7) being preheated with the help of a gaseous heat carrier which flows in a cycle around the protective covers (7) on the outside and absorbs heat from annealing material (5) which is already heat-treated in a protective cover (7) and emits it to the annealing material (4) to be preheated in the other protective cover (7), wherein for the heat treatment of the annealing material (4, 5, 6) at least one further annealing base (3) is used which comprises a protective hood (7) which is heatable from the outside by a burner (15), and wherein the hot exhaust gases from the heating of said protective hood (7) are admixed into the heated heat carrier for preheating the annealing material (4).

2. A hood-type annealing system for performing the method according to claim 1, comprising annealing bases (1, 2) which accommodate the annealing material (4, 5) under a protective hood (7), circulation devices associated with the protective hoods (7) for a protective gas and a cycle guidance for a gaseous heat carrier which comprises enclosures (10) which enclose the protective hoods (7) at a distance and flow conduits (11, 12) which join the enclosures (10) with each other into a cycle, wherein at least one further annealing base (3) with a protective hood (7) and a heating hood (14) which is heatable by a burner (15) and encloses the protective hood (14) are provided, the exhaust gas line (17) of which opens into the flow conduit (12) for the heated heat carrier, and wherein the flow conduit (11) for the cooled heat carrier is provided with an excess outlet (19).

3. A hood-type annealing system according to claim 2, wherein the cycle guidance for the heat carrier comprises at least one cycle blower (13) which is controllable depending on the pressure in the flow conduit (12) for the heated heat carrier.
